(19) United States
(12) Patent Application Publication
(10) Pub. No.: US 2014/0176433 A1
(43) Pub. Date: Jun. 26, 2014

(54) INTERACTIVE PROJECTION SYSTEM, PROJECTOR THEREOF, AND CONTROL METHOD THEREOF

(71) Applicant: AZUREWAVE TECHNOLOGIES, INC., NEW TAIPEI CITY (TW)

(72) Inventor: CHIEN-BIN HUANG, TAIPEI CITY (TW)

(73) Assignee: AZUREWAVE TECHNOLOGIES, INC., NEW TAIPEI CITY (TW)

(21) Appl. No.: 13/844,887

(22) Filed: Mar. 16, 2013

(30) Foreign Application Priority Data
Dec. 24, 2012 (TW) 101149508

(51) Int. Cl. G06F 3/033

(52) U.S. Cl. CPC G06F 3/033
USPC 345/157

(57) ABSTRACT

The present invention discloses an interactive projection system including a pointing device and a projector. The pointing device is used to generate a light spot. The projector includes a projecting module, an image capturing module, and a processing module, and the projector includes a built-in operating system. The operating system includes a plurality of applications with graphical user interfaces. The projecting module projects a projected image being present of the operating system onto a screen. The image capturing module captures an image generated by projecting the light spot onto the screen. The processing module calculates a coordinate of the light spot according to the above-mentioned image, and determines whether the light spot has stayed on the graphical user interface associated with one of the applications on the projection screen, so as to execute the application corresponding to the light spot.

### BACKGROUND

1. Technical Field

The present disclosure relates to a projection system, in particular, to an interactive projection system, a projector thereof and a control method thereof.

2. Description of Related Art

A conventional projector needs to be electrically coupled to a host device, such as a desktop computer or a laptop, for projecting a displayed image of the host device onto a screen to form a projected image. Accordingly, an operation (such as pause or play) of the conventional projector can be achieved via a remote controller associated to the projector, or via a device button of the projector. Hence not much HMI (human-machine interaction) between the projector and a user is required.

As technology of system integration improves in recent years, projectors with built-in OS (Operating System) starts to emerge. However, when operating a projector with a built-in OS, the conventional operating method of utilizing the remote controller or the device button of the projector becomes inconvenient. This is mainly due to an OS requires more than simple operations such as pause and play, etc.

For instance, when a user is to type a text instruction to the projector with the built-in OS, the remote controller has to possess a keyboard, or a plurality of keys, to achieve the function of inputting the text instruction. Consequently, this causes inconvenience to the user during inputting text instructions, which leads to unsatisfactory user experience.

### SUMMARY

An exemplary embodiment of the present disclosure provides an interactive projection system. The interactive projection system comprises a pointing device and a projector. The pointing device is used to generate a light spot. The projector is with an operating system. The operating system comprises a plurality of applications with graphical user interfaces. The projector comprises a projecting module, an image capturing module and a processing module. The projecting module is for projecting a projected image being present of the operating system onto a screen. The image capturing module is for capturing an image generated by projecting the light spot onto the screen. The processing module is for obtaining a coordinate of the light spot according to the image generated by projecting the light spot onto the screen, and determining whether the light spot has stayed on the graphical user interface associated with an application of the plurality of applications on the projected image, so as to execute the application corresponding to the light spot.

Another exemplary embodiment of the present disclosure provides a projector. The projector has a built-in operating system. The operating system has a plurality of applications with corresponding graphical user interfaces. The projector comprises a projecting module, an image capturing module and a processing module. The projecting module is for projecting a projected image being present of the operating system onto a screen. The image capturing module is for capturing an image generated by projecting a light spot onto the screen. The light spot is generated by a pointing device. The processing module is for obtaining a coordinate of the light spot according to the image generated by projecting the light spot onto the screen, and determining whether the light spot has stayed on the graphical user interface associated with an application of the plurality of applications on the projected image, so as to execute the application corresponding to the light spot.

Another exemplary embodiment of the present disclosure provides a control method for controlling a projector. The control method comprises projecting a projected image being present of an operating system built-in to the projector onto a screen, wherein the operating system comprises a plurality of applications with corresponding graphical user interfaces; capturing an image generating by projecting the light spot onto the screen, wherein the light spot is generated by a pointing device; determining whether the light spot has stayed on the graphical user interface associated with an application of the plurality of applications; and executing the application corresponding to the light spot, if the light spot has stayed on the application of the plurality of applications.

To sum up, the present disclosure discloses an interactive projection system, a projector thereof and a control method thereof. In addition to a built-in operating system, the projector can determine whether a light spot generated by a pointing device has projected onto a graphical user interface corresponding to an application via operation of an image capturing module and a processing module in the projector, for achieving whether to execute the application or not.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a diagram illustrating operation of an interactive projection system according to an embodiment of the present disclosure.

FIG. 1B is a diagram illustrating operation of the interactive projection system according to another embodiment of the present disclosure.

FIG. 2 is a diagram illustrating function blocks of the interactive projection system according to an embodiment of the present disclosure.

FIG. 3 is a diagram illustrating interface of an operating system of a projector according to an embodiment of the present disclosure.

FIG. 4 is a flow chart illustrating a control method for controlling a projector according to an embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

(An Embodiment of an Interactive Projection System)

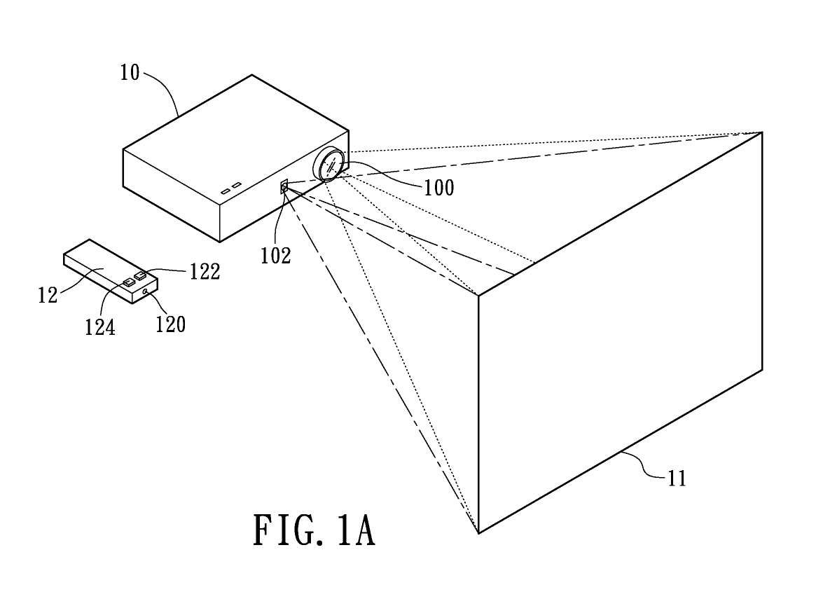

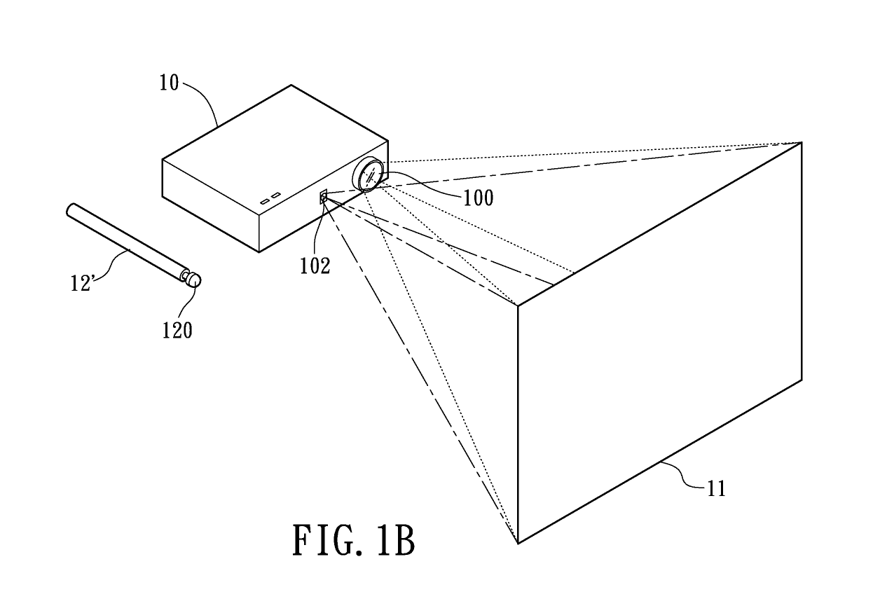

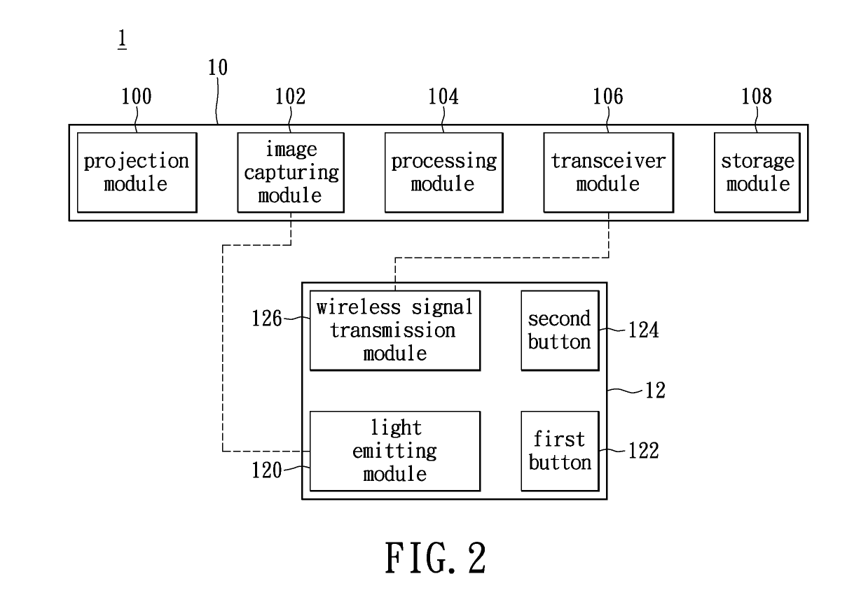

Please refer to FIG. 1A and FIG. 2. FIG. 1A is a diagram illustrating operation of an interactive projection system according to an embodiment of the present disclosure. FIG. 2 is a diagram illustrating function blocks of the interactive projection system according to an embodiment of the present disclosure. As shown in FIG. 1A and FIG. 2, the interactive projection system 1 comprises a projector 10, a screen 11 and a pointing device 12.

The projector has a built-in OS (Operating System). The OS has a plurality of APPs (applications) with GUIs (Graphical User Interface). In other words, the APPs are presented in the OS by using the corresponding GUIs. More specifically, the projector 10 of the present disclosure can directly project a projected image being present of the OS onto the screen 11, and that is, the projected image on the screen 11 shows a window of the OS. Practically, the built-in OS of the projector 10 can be Microsoft Windows, Apple iOS or Google Android, etc., but the present disclosure is not limited thereto.

The projector 10 of the present disclosure can directly project the projected image being present of the OS onto the screen 11 without requiring to be coupled to a host device (e.g. a desktop computer, a laptop, a smart phone or a game console, etc.). However, to those skilled in the art, the projector 10 can further be electrically coupled to the host device, such that the projected image on to the screen 11 can show the image which the monitor of the host device displays according to the data stored in the host device. Further, the present disclosure does not limit a signal transmission method between the host device and the projector 10. The signal transmission method can be, for instance, transmission utilizing a physical wiring or transmission utilizing a wireless communication protocol.

Generally, the screen 11 can be disposed in front of a projection hole of the projector 10. A background of the screen 11 is usually white, in order to facilitate projection operation of the projector 10 to form a projected image. However, since the screen 11 merely provides a plane which is being projected on without performing actions, the screen 11 is not illustrated as part of the function block shown in FIG. 2. This does not mean the interactive projection system 1 does not require utilizing the screen 11.

Practically, the pointing device 12 is usually designed to have a pen-type casing or a rectangular casing, for make user operation easier. A user can utilize a finger to press a first button 122, for a light emitting module 120 which is in front of the pointing device 12 to generate a light spot accordingly. In other words, the pointing device 12 of the present disclosure can be any devices comprising the light emitting module 120 which is capable of generating a light spot. Please refer to FIG. 1B. FIG. 1B is a diagram illustrating operation of the interactive projection system according to another embodiment of the present disclosure. As shown in FIG. 1B, a pointing device 12′ can be a device that automatically emits light via the light emitting module 120 without pressing any buttons. Further, a light spot generated by the light emitting module 120 can be a laser light spot or an infrared light spot, but the present disclosure is not limited thereto. Components of the interactive projection system 1 are explained in detail below.

As shown in FIG. 2, the projector 10 comprises a projection module 100, an image capturing module 102, a processing module 104, a transceiver module 106 and a storage module 108. The projection module 100 is for projecting a window of an operating system, which is built-in to the projector 10, onto the screen 11 so as to generate a projected image. Practically, the projection module 100 of the projector 10 of the present disclosure can also receive a displayed image of the host device, and then projects the displayed image onto the screen 11 for generating a projected image corresponding to the displayed image of the host device.

The image capturing module 102 is for capturing an image generated by projecting the light spot (which is generated by the pointing device 12) onto the screen 11. Generally, the image capturing module 102 is disposed at the same side as the projection hole. A capturing range of the image capturing module 102 equals approximately the size of the screen 11, for completely capturing the image projected by the pointing device 12 on the screen 11. The image capturing module 102 can be an image sensing component comprising a charge coupled device (CCD) or a complementary metal oxide semiconductor (CMOS), but the present disclosure is not limited thereto.

An image captured by the image capturing module 102 of the present disclosure corresponds to type of the light spot generated by the light emitting module 120. For instance, if the light spot generated by the light emitting module 120 is of an infrared light spot, the image capturing module 102 can then capture an infrared light spot with a wavelength of 0.75 μm˜1.4 μm (i.e. near-infrared), or an infrared light spot with a wavelength of 1.4 μm˜3 μm (i.e. short-wavelength infrared). Similarly, to those skilled in the art, the image capturing module 102 can also be designed to capture an infrared light spot with a wavelength of 3 μm˜8 μm (i.e. mid-infrared), an infrared light spot with a wavelength of 8 μm˜15 μm (i.e. long-infrared) or an infrared light spot with a wavelength of 15 μm˜1000 μm (i.e. far-infrared), etc.

On the other hand, if the light spot generated by the light emitting module 120 is of a laser light spot, the image capturing module 102 can then capture a red laser with a wavelength of 650 nm˜660 nm, a green laser with a wavelength of 532 nm, a blue laser with a wavelength of 445 nm˜450 nm or a blue-velvet laser with a wavelength of 405 nm, etc., but the present disclosure is not limited thereto.

The image capturing module 102 described in an embodiment of the present disclosure is disposed in the projector 10, for the projector 10 of the embodiment of the present disclosure to possess functions of projecting image and capturing light spot. However, to those skilled in the art, the image capturing module 102 can also be designed as an external light spot capturing device. In other words, the external light spot capturing device can be an independently operating device, electrically coupled (whether directly or indirectly) to the projector 10.

The processing module 104 calculates a coordinate of the light spot on the screen 11, according to an image of the light spot (generated by the pointing device 12) being projected on the screen 11. Practically, the processing module 104 performs coordinate calculation to each image captured by the image capturing module 102 in a time duration, for obtaining all coordinates and coordinate variations of the light spot on the screen 11 within the time duration, so as to determine whether the light spot has stayed on the graphical user interface associated with any of the applications displayed on the projected image.

The transceiver module 106 is for performing signal transmission with an external electronic device (e.g. a remote server or the pointing device 12). The present disclosure does not limit the transceiver module 106 to perform wired or wireless transmission. Practically, the projector 10 of the present disclosure can be coupled to a remote Appstore via the transceiver module 106, and selectively download application in the Appstore, for increasing amount and function of applications in the operating system of the projector 10.

The storage module 108 is for storing all data, such as the operating system and the applications mentioned above in the projector 10. Practically, the storage module 108 can be read-only memory (ROM) of non-volatile memory, or flash memory, but the present disclosure is not limited thereto.

The pointing device 12 comprises the light emitting module 120, the first button 122, a second button 124 and a wireless signal transmission module 126, where the first button 122 and the second button 124 are disposed on casing surface of the pointing device 12. The light emitting module 120 is controlled by the first button 122, for generating a light spot. Hence, when the first button 122 is triggered, the light emitting module 120 generates the light spot immediately. In other words, when the first button 122 is triggered, the light emitting module 120 generates the light spot due to an input voltage is converted from a low potential to a high potential. When the first button 122 stops being triggered, the light emitting module 120 terminates generating the light spot due to the input voltage is dropped from the high potential to the low potential.

The wireless signal transmission module 126 is controlled by the second button 124, for selectively transmitting a set of wireless signals to the projector 10. Function of an operation command of the projector 10 is enabled according to the wireless signal. Generally, the wireless signal can be in a form of radio frequency (RF), and a relative typical operational frequency range can be classified into a low-frequency band of 30 KHz˜300 KHz, a medium-frequency band of 300 KHz˜3 MHz and a high-frequency band of 3 MHz˜30 MHz. To those skilled in the art, an extreme-low frequency band of 3 KHz˜30 KHz to an extreme-high frequency band of 30 GHz˜300 GHz can also be utilized, but the present disclosure is not limited thereto.

According to one embodiment of the present disclosure, when the first button 122 is triggered, the processing module 104 in the projector 10 calculates a coordinate of the light spot on the screen 11 according to a projected image generated by projecting the light spot onto the screen 11, for determining whether the light spot has stayed on the graphical user interface associated with any of the above mentioned applications on the projected image for over a predetermined duration. If a duration of the light spot staying on the graphical user interface associated with an application exceeds the predetermined duration, the application is then accordingly executed. In other words, the interactive projection system 1 of the present disclosure determines whether the light spot has located on a graphical user interface of the application, according to the coordinate of the light spot calculated by the processing module 104. When the interactive projection system 1 detects the light spot has begun staying on the graphical user interface mentioned above, the interactive projection system 1 starts calculating whether a duration of the light spot staying on the graphical user interface has exceeded a predetermined duration of the projector 10, for determining whether to execute the application corresponding to the graphical user interface or not.

According to another embodiment of the present disclosure, when the processing module 104 determines the light spot has stayed on the graphical user interface associated with one of the applications mentioned above, the second button 124 can be triggered for the wireless signal transmission module 126 to transmit a set of wireless signals denoting “enter” to the projector 10, for the projector 10 to directly execute the application corresponding to the light spot.

The present disclosure does not limit the second button 124 to be the only button to enable an operation command of “enter” of the projector 10. More specifically, when the second button 124 is triggered, the wireless signal transmission module 126 transmits a set of wireless signals to the projector 10, for an image projected onto the screen 11 by the projector 10 to generate a function menu. The function menu can correspondingly indicate an operation command of the projector 10. Practically, the operation command of the projector 10 of the present disclosure 10 comprises “pause”, “play”, “home”, “main menu”, “enter”, “back”, “mode”, “volume” or “on-screen keyboard”, etc. Those skilled in the art can also configure options such as visual effect, graphic equalizer, play speed setting or subtitle on/off, etc. as part of the operation command, but the present disclosure is not limited thereto.

Accordingly, a method to select operation command can also be according to whether a duration of the light spot staying on the graphical user interface of a function menu has exceeded the above mentioned predetermined duration, for executing an operation command corresponding to the light spot on the function menu. Those skilled in the art can further set, for instance, a third button (not illustrated in drawings), for configuring the three buttons to correspond to functions of “light on”, “enter” and “function menu”, etc. When a user has triggered one of the buttons to bring out the function menu on the projected image, the user needs to trigger another button to execute an operation command corresponding to the light spot on the graphical user interface of the function menu. Detailed operation is similar to those mentioned above, so relative descriptions are omitted hereinafter.

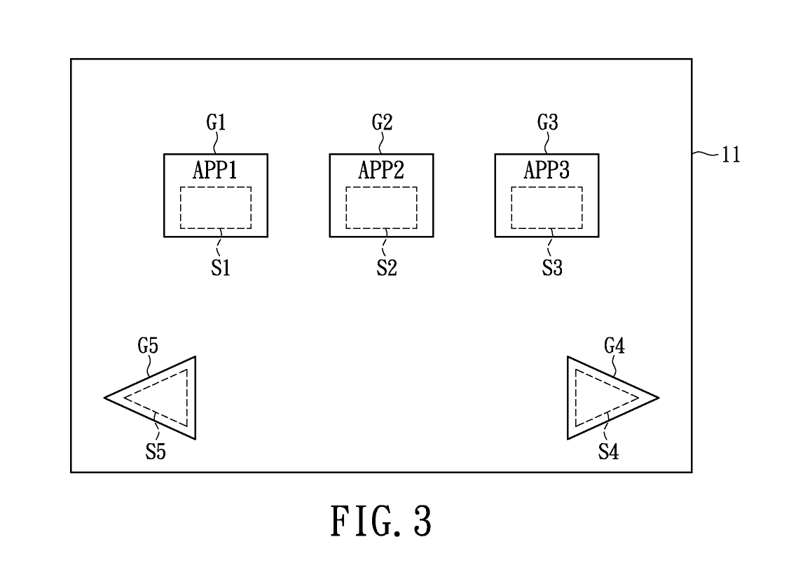

For better illustrating practical operation of the interactive projection system 1 of the present disclosure, please refer to FIG. 3. FIG. 3 is a diagram illustrating interface of an operating system of a projector according to an embodiment of the present disclosure. As shown in FIG. 3, when a built-in operating system of the projector 10 is projected onto the screen 11, a corresponding projected image is generated. The projected image shown in FIG. 3 comprises a plurality of graphical user interfaces G1˜G3 representing a plurality of applications APP1˜APP3, graphical user interface G4 representing “page right” (also known as “next page”) and graphical user interface G5 representing “page left” (also known as “previous page”), where each of the graphical user interfaces G1˜G5 comprises a sensing area S1˜S5 respectively.

When the projector 10 detects the light spot is projected on any of the sensing areas of the graphical user interfaces G1˜G5, the processing module 104 begins calculating whether a duration of the light spot staying on the above mentioned sensing area has exceeded a predetermined duration. If the predetermined duration is exceeded, an application of the corresponding graphical user interface is executed accordingly. In other words, when a coordinate of the light spot is located in one of the sensing areas, the processing module 104 begins calculating a duration of the light spot staying on the one sensing area of the sensing areas.

Generally, the predetermined duration of the projector 10 is between 0.5˜0.8 seconds, for instance. Those skilled in the art can certainly set the predetermined duration according to practical needs. Further, the present disclosure does not limit size of the sensing area S1˜S5 on the respective graphical user interface G1˜G5, but a maximum sensing range of the sensing area S1˜S5 can correspond to border of the respective graphical user interface G1˜G5. In other words, once the light spot projected onto any of the graphical user interfaces G1˜G5 the light spot has entered the sensing range, and calculation for a duration of the light spot staying on the graphical user interface begins.

(Embodiment of a Control Method for Controlling a Projector)

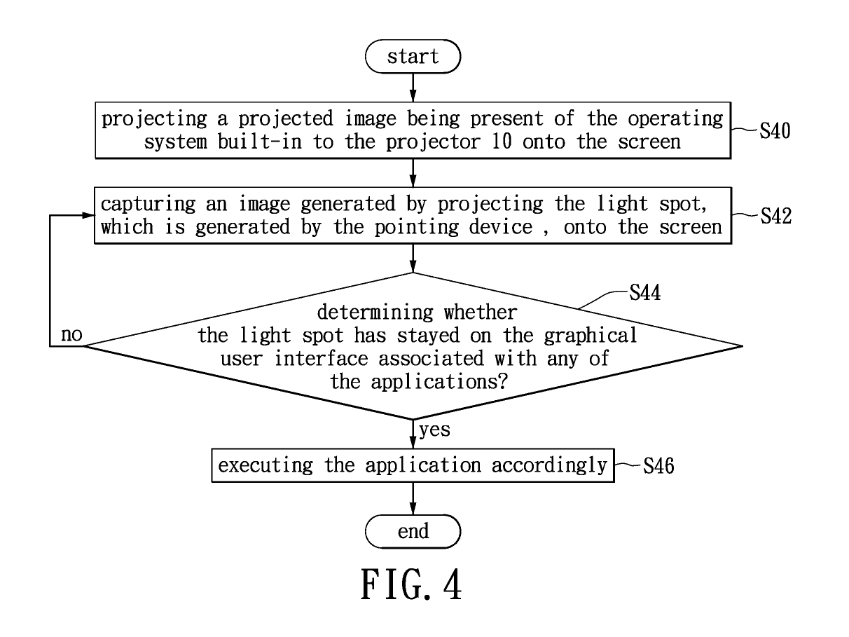

Please refer to FIG. 2 and FIG. 4. FIG. 4 is a flow chart illustrating a control method for controlling a projector according to an embodiment of the present disclosure. As shown in FIG. 4, in step S40, a projected image being present of the operating system built-in to the projector 10 is projected onto the screen 11, wherein the operating system of the projector 10 has a plurality of applications with corresponding graphical user interfaces.

In step S42, the projector 10 starts capturing an image generated by projecting the light spot, which is generated by the pointing device 12, onto the screen 11. Then, in step S44, the projector 10 determines whether the light spot has stayed on the graphical user interface associated with any of the applications.

If the light spot has stayed on an application, the application is executed accordingly (step S46). If the light spot has not stayed on the graphical user interface associated with any of the applications, the method goes back to the step S42.

Further, the step S44 further comprises determining whether a duration of the light spot staying on the graphical user interface associated with one of the applications has exceeded a predetermined duration. If the duration of the light spot staying on the graphical user interface associated with an application exceeds the predetermined duration, the application corresponding to the light spot is executed accordingly.

In a preferred embodiment, the pointing device 12 possesses a first button. When it is determined that the light spot has stayed on the graphical user interface associated with one of the applications, the application corresponding to the light spot is executed via triggering the first button.

In another preferred embodiment, the pointing device 12 possesses a second button. When the second button is triggered, a function menu is generated in the projected image. The function menu correspondingly indicated an operation command of the operating system in the projector 10.

(Possible Effects of the Embodiments)

In summary, embodiments of the present disclosure disclose an interactive projection system, projector thereof and control method thereof. In addition to a built-in operating system, the projector can determine whether a light spot generated by a pointing device has projected onto a graphical user interface corresponding to an application via operation of an image capturing module and a processing module in the projector, for achieving whether to execute the application or not. Accordingly, the interactive projection system of the present disclosure, the projector thereof and the control method thereof can increase fluency and intuition of operating a human-machine interface and eliminate complex operation of a remote control of a conventional projector remote.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An interactive projection system, comprising:
a pointing device, for generating a light spot; and
a projector, with a built-in operating system, wherein the operating system comprises a plurality of applications with graphical user interfaces, the projector comprises:
a projecting module, for projecting a projected image being present of the operating system onto a screen;
an image capturing module, for capturing an image generated by projecting the light spot onto the screen; and
a processing module, for obtaining a coordinate of the light spot according to the image generated by projecting the light spot onto the screen, and determining whether the light spot has stayed on the graphical user interface associated with an application of the plurality of applications on the projected image, so as to execute the application corresponding to the light spot.

2. The interactive projection system according to claim 1, wherein when the processing module determines a duration of the light spot staying on the graphical user interface associated with the application of the plurality of applications on the projected image has exceeded a predetermined duration, the application corresponding to the light spot is executed.

3. The interactive projection system according to claim 1, wherein the pointing device further comprises a first button, when the light spot has stayed on the graphical user interface of the application of the plurality of applications on the projected image, the application corresponding to the light spot is executed via triggering the first button.

4. The interactive projection system according to claim 1, wherein the pointing device further comprises a second button, when the second button is triggered, a function menu is generated in the projected image and the function menu correspondingly indicates an operation command of the operating system.

5. A projector, the projector having a built-in operating system, the operating system having a plurality of applications with corresponding graphical user interfaces, the projector comprising:
a projecting module, for projecting a projected image being present of the operating system onto a screen;
an image capturing module, for capturing an image generated by projecting a light spot onto the screen, wherein the light spot is generated by a pointing device; and
a processing module, for obtaining a coordinate of the light spot according to the image generated by projecting the light spot onto the screen, and determining whether the light spot has stayed on the graphical user interface associated with an application of the plurality of applications on the projected image, so as to execute the application corresponding to the light spot.

6. The projector according to claim 5, wherein when the processing module determines a duration of the light spot staying on the graphical user interface associated with the application of the plurality of applications on the projected image has exceeded a predetermined duration, the application corresponding to the light spot is executed.

7. A control method for controlling a projector, comprising:
projecting a projected image being present of an operating system built-in to the projector onto a screen, wherein the operating system comprises a plurality of applications with corresponding graphical user interfaces;
capturing an image generating by projecting the light spot onto the screen, wherein the light spot is generated by a pointing device;
determining whether the light spot has stayed on the graphical user interface associated with an application of the plurality of applications; and
executing the application corresponding to the light spot, if the light spot has stayed on the graphical user interface associated with the application of the plurality of applications.

8. The control method for controlling the projector according to claim 7, wherein determining whether the light spot has stayed on the graphical user interface associated with the application of the plurality of applications further comprises determining whether a duration of the light spot staying on the graphical user interface associated with the application of the plurality of applications on the projected image has exceeded a predetermined duration, if the predetermined duration is exceeded, the application corresponding to the light spot is executed.

9. The control method for controlling the projector according to claim 7, wherein the pointing device comprises a first button, when the light spot has stayed on the graphical user interface associated with the application of the plurality of applications on the projected image, the application corresponding to the light spot is executed via triggering the first button.

10. The control method for controlling the projector according to claim 7, wherein the pointing device comprises a second button, when the second button is triggered, a function menu is generated in the projected image and the function menu correspondingly indicates to an operation command of the operating system.
